(19) United States
(12) Patent Application Publication
(10) Pub. No.: US 2010/0211395 A1
(43) Pub. Date: Aug. 19, 2010

(54) Method and System for Speech Intelligibility Measurement of an Audio Transmission System

(75) Inventors: John Gerard Beerends, Hengstdijk (NL); Jeroen Martijn Van Vugt, The Hague (NL); Ronald Alexander Van Buuren, Bodegraven (NL)

Correspondence Address: MCDONNELL BOEHNEN HULBERT & BERGHOFF LLP, 300 S. WACKER DRIVE, 32ND FLOOR, CHICAGO, IL, 60606, US

(73) Assignees: KONINKLIJKE KPN N.V., The Hague (NL); NEDERLANDSE ORGANISATIE VOOR TOEGEPAST-NATUURWETENSCHAPPELIJK ONDERZOEK TNO, Delft (NL)

(21) Appl. No.: 12/682,198

(22) PCT Filed: Oct. 6, 2008
(86) PCT No.: PCT/EP08/08410

§ 371 Date: Apr. 8, 2010

(30) Foreign Application Priority Data
Oct. 11, 2007 (EP) 07019894.0

(51) Int. Cl. G10L 21/00

(52) U.S. Cl. 704/270; 704/E21.001

(57) ABSTRACT

Method and processing system for measuring the intelligibility of a degraded output signal (Y(t)) from an audio transmission system (10) in response to a reference input signal (X(t)). A measurement device (11) is arranged for outputting a measure (I) for the speech intelligibility of the output signal (Y(t)). The measurement device (11) executes processing of the input signal (X(t)) and output signal (Y(t)) to obtain a disturbance density function (D(f)ₙ). The disturbance density function (D(f)ₙ) is corrected by multiplying it with a correction function for each frame derived from a correlation calculation of the compensated pitch power densities (PPX′(f)ₙ) associated with the input signal (X(t)) of a present frame (n) and an independent previous frame (n−2). The corrected disturbance density function (D′(f)ₙ) is aggregated over frequency and time to obtain a measure (I) for the speech intelligibility of the output signal (Y(t)).

### FIELD OF THE INVENTION

The present invention relates to a method for measuring the speech intelligibility of an audio transmission system, an input signal X(t) being entered into the system, resulting in an output signal Y(t), in which both the input signal X(t) and the output signal Y(t) are processed. In a further aspect, the present invention relates to a processing system for measuring the intelligibility of a degraded output signal Y(t) from an audio transmission system in response to a reference input signal X(t).

### PRIOR ART

A related method and system are known from ITU-T recommendation P.862, “Perceptual evaluation of speech quality (PESQ), an objective method for end-to-end speech quality assessment of narrow-band telephone networks and speech codecs”, ITU-T 02.2001 [3].

Also, the article by J. Beerends et al. “PESQ, the new ITU standard for objective measurement of perceived speech quality, Part II—Perceptual model,” J. Audio Eng. Soc., vol. 50, pp. 765-778 (2002 October), describes such a method and system [2].

The present invention is a further development of the idea that speech and audio intelligibility measurement should be carried out in the perceptual domain. In general this idea results in a system that compares a reference speech signal with a distorted signal that has passed through the system under test. By comparing the internal perceptual representations of these signals, estimation can be made about the perceived intelligibility. The latest technology relating to similar quality measurement in this field can be found in references [1] . . . [11]. All currently available systems suffer from the fact that speech intelligibility cannot be measured. In a database that was constructed with a CVC (Consonant Vowel Consonant) identification task, the correlation between CVC correct scores and raw PESQ scores was below 0.6. The currently best method for measuring speech intelligibility is the STI (Speech Transmission Index), see references [12] . . . [15]. However the STI method uses a modulated noise, speech like, test signal and can only be used under a limited set of distortions.

### SUMMARY OF THE INVENTION

The present invention seeks to provide a new measurement method and apparatus for measuring the intelligibility of speech as output in a speech/audio communication system.

According to the present invention, a method according to the preamble defined above is provided, in which the method comprises:

preprocessing of the input signal (X(t)) and output signal (Y(t)) to obtain pitch power densities (PPX(f)ₙ, PPY (f)ₙ) for the respective signals, comprising pitch power density values for cells in the frequency (j) and time (n) domain;

compensating the pitch power densities to obtain compensated pitch power densities (PPX′(f)ₙ, PPY′(f)ₙ;

transforming the compensated pitch power densities (PPX′(f)ₙ, PPY′(f)ₙ) in loudness densities (LX(f)ₙ, LY(f)ₙ);

perceptual subtraction of the loudness densities (LX(f)ₙ, LY(f)ₙ) to obtain a disturbance density function (D(f)ₙ);

correction of the disturbance density function (D(f)ₙ) by multiplying the disturbance density function (D(f)ₙ) with a correction function for each frame derived from a correlation calculation of the compensated pitch power density (PPX′(f)ₙ) associated with the input signal (X(t)) of a present frame (n) and an independent previous frame (n−2) to obtain a corrected disturbance density function (D′(F)ₙ); and

aggregating the corrected disturbance density function (D′(f)ₙ) over frequency and time to obtain a measure (I) for the speech intelligibility of the output signal (Y(t)).

With the term independent previous frame it is meant to have a previous frame which does not have any overlap with the present frame. E.g. the frames may have a 50% overlap, in which case the compensated pitch power density associated with the present frame n is correlated with compensated pitch power density associated with the second previous frame n−2.

By correcting the disturbance density function in the described manner, the correlation between the measure for the speech intelligibility as calculated by the present method embodiment and actual speech intelligibility scores are improved. The present invention is based on the insight that when two frames in a speech signal are alike, degradations as found by the prior art PESQ method is causing less decrease in intelligibility than predicted. When a subject is hearing a sound a second time, the subject is able to better understand it than the first time the (same) sound is heard.

In a further embodiment, the correction function (frameCorTimeOrg(n)) is calculated according to:

frameCorTimeOrg(n)=frameCorTimeOrg(n)=FrequencybandCorrelation(PPX′(f)ₙ,PPX′(f)ₙ₋₂)

In the existing PESQ method, such a feature allows to easy amend the method to the changed insight for predicting speech intelligibility scores.

In an even further embodiment, correlation calculation is executed over a frequency domain range from a low frequency limit to a high frequency limit, such as the range from 100 . . . 3500 Hz. As this corresponds to the general speech frequency range, it is sufficient to restrict the calculations to this range for predicting intelligibility of a sound signal.

The correction function is limited to a value less or equal to 1.0, according to the rules:

if frameCorTimeOrg(n) < 0.0

frameCorrelationTimeCompensation = 1.0

else

frameCorrelationTimeCompensation = 1.0 −
( frameCorTimeOrg(n) )^{k},

k being a predetermined power value.

The predetermined power value may be larger than 1.0, e.g. between 10 and 20. In this manner, the method incorporates that for low correlations, the impact on the intelligibility score is marginal, and only correlations close to 1.0 are included more pronounced as their impact is significant.

In an even further embodiment, the correction function is limited to a value larger than or equal to a lower limit value, e.g. 0.4. This assures that the corrections as applied to the disturbance density functions is not influenced too heavily for strong correlating frames.

As in the prior art PESQ method, the (corrected) disturbance density function is aggregated over the frequency and time domain, to yield a measure in the form of a value. From this measure, the speech intelligibility may be provided with a score, e.g. using a mapping similar to a CVC intelligibility score.

Specific for the measurement of intelligibility, the aggregation functions over frequency and time are adapted. In a further embodiment, the corrected disturbance density function D′(f)ₙ is aggregated over frequency using a low norm factor (L_{q}), in which the low norm factor (L_{q}) has a value of less than or equal to 2, and aggregated over time using a high norm factor (Lₚ), in which the high norm factor (Lₚ) has a value of greater than or equal to 6.

In a further embodiment, the method further comprises calculating a difference between two intelligibility score measures (I), in which the intelligibility score measures (I) are calculated using different norm factors, the norm factors being less than or equal to 3. This provides an even further improved intelligibility score measurement, which is even closer to actual subjective tests.

In a further aspect, the present invention relates to a processing system as described above, comprising a processor connected to the audio transmission system for receiving the reference input signal X(t) and the degraded output signal Y(t), in which the processor is arranged for outputting a measure I for the speech intelligibility of the output signal Y(t), and for executing the steps of the method according to any one of the present method embodiments.

In an even further aspect, the present invention relates to a computer program product comprising computer executable software code, which when loaded on a processing system, allows the processing system to execute the method according to any one of the present method embodiments.

### SHORT DESCRIPTION OF DRAWINGS

The present invention will be discussed in more detail below, using a number of exemplary embodiments, with reference to the attached drawings, in which

FIG. 1 shows a block diagram of an application of the present invention;

FIG. 2 shows a flows chart of the implementation of an embodiment of the present invention.

### DETAILED DESCRIPTION OF EXEMPLARY EMBODIMENTS

During the past decades a number of measurement techniques have been developed that allow to quantify the quality of audio devices in a way that closely copies human perception. The advantage of these methods over classical methods that quantify the quality in terms of system parameters like frequency response, noise, distortion, etc is the high correlation between subjective measurements and objective measurements. With this perceptual approach a series of audio signals is input into the system under test and the degraded output signal is compared with the original input to the system on the basis of a model of human perception. On the basis of a set of comparisons the intelligibility of the system under test can be quantified.

The perceptual model uses the basic features of the human auditory system to map both the original input and the degraded output onto an internal representation. If the difference in this internal representation is zero the system under test is transparent for the human observer representing a perfect system under test (from the perspective of perceived audio intelligibility). If the difference is larger then zero it is mapped to an intelligibility number using a cognitive model, allowing quantifying the perceived degradation in the degraded output signal.

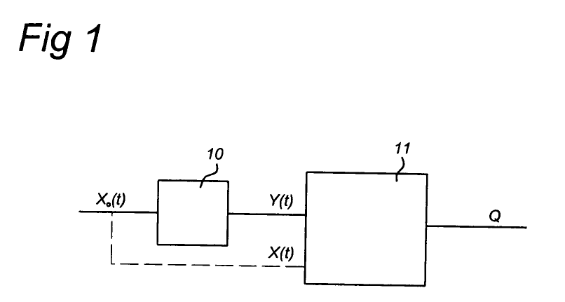

FIG. 1 shows schematically a known set-up of an application of an objective measurement technique which is based on a model of human auditory perception and cognition, and which follows the ITU-T Recommendation P.862 (see reference [3]), for estimating the perceptual quality of speech links or codecs, which can also be applied for the present invention relating to intelligibility measurement. The acronym used for this technique or device is PESQ (Perceptual Evaluation of Speech Quality). It comprises a system or telecommunications network under test 10, hereinafter referred to as system 10, and a measurement device 11 for the perceptual analysis of speech signals offered. A speech signal Xₒ(t) is used, on the one hand, as an input signal of the system 10 and, on the other hand, as a first input signal X(t) of the device 11. An output signal Y(t) of the system 10, which in fact is the speech signal Xₒ(t) affected or degraded by the system 10, is used as a second input signal of the measurement device 11. An output signal I of the measurement device 11 represents an estimate of the perceptual intelligibility of the speech link through the system 10.

The measurement device 11 may be implemented as a processing system comprising a dedicated signal processing unit, e.g. having one or more (digital) signal processors, or a general purpose processing system having one or more processors under the control of a software program comprising computer executable code. The device II is provided with suitable input and output modules and further supporting elements for the processors, such as memory, as will be clear to the skilled person.

Since the input end and the output end of a speech link (shown as the system 10 in FIG. 1), particularly in the event it runs through a telecommunications network, are remote, use is made in most cases of speech signals X(t) stored on data bases for the input signals of the measurement device 11. Here, as is customary, speech signal is understood to mean each sound basically perceptible to the human hearing, such as speech and tones. The system under test 10 may of course also be a simulation system, which e.g. simulates a telecommunications network.

The present invention solves the problem of low correlation between the PESQ scores and speech intelligibility scores by an additional new processing step for calculating the internal representation of the speech signal. It uses PESQ P.862.1 (reference [4]) and P.862.2 (reference [5]) as the starting point for an algorithm that can predict the perceived speech intelligibility of a speech fragment. The documents reference [3], [4], and [5] are incorporated herein for the general steps of the PESQ method.

The present method can be used on normal speech material as well as on a short CVC test signal (Consonant Vowel Consonant). This test signal Xₒ(t) contains a set of short speech fragments, concatenated CVC words as used in speech intelligibility testing, that contains all relevant vowels and consonants, including the relevant transitions, and is put into the system under test 10.

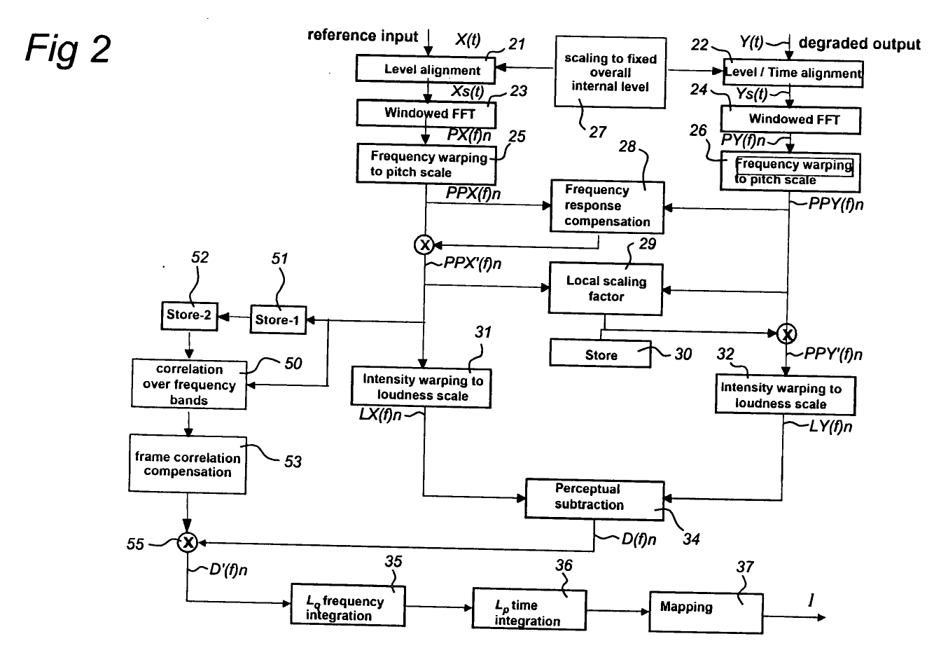

In FIG. 2, a flow chart is shown in schematic form of an embodiment of the present invention, which may be implemented in the measurement device 11 shown in FIG. 1. The starting processing blocks 21-34, as well as the final blocks 35-37 are the general processing steps applied in PESQ, see reference [3], although it should be noted that other embodiments comprising one or more additional or amended processing steps are possible, to obtain more specialized measuring methods or measuring methods with other objectives. These starting blocks 21-34 will be discussed in short, after which the further processing steps 50-55 of the present method embodiment are discussed in more detail, as well as the final blocks 35-37.

The first step in the PESQ algorithm is to compensate for the overall gain of the system under test, which is executed in the level and level/time alignment blocks 21, 22. These steps 21, 22 are combined with a global scaling of the signals to a correct overall level in block 27. Both the original X(t) (reference input signal) and degraded (output) signal Y(t) are scaled to the same, constant power level, resulting in signals Xₛ(t) and Yₛ(t).

Then, these signals are subjected to a windowed fast Fourier transform operation, in respective blocks 23, 24, resulting in the power representation arrays PX(f)ₙ and PY(f)ₙ. The human ear performs a time-frequency transformation. In PESQ this is modelled by a short term FFT with a Hann window over 32 ms frames. The overlap between successive frames is 50%. The power spectra—the sum of the squared real and squared imaginary parts of the complex FFT components—are stored in separate real valued arrays for the original and degraded signals. Phase information within a single frame is discarded in PESQ and all calculations are based on only the power representations PX(f)ₙ and PY(f)ₙ.

In the next processing blocks, both power representation arrays PX(f)ₙ and PY(F)ₙ are subjected to a frequency warping operation to a pitch scale in processing blocks 25 and 26, respectively. The Bark scale reflects that at low frequencies, the human hearing system has a finer frequency resolution than at high frequencies. This is implemented by binning FFT bands and summing the corresponding powers of the FFT bands with a normalization of the summed parts. The warping function that maps the frequency scale in Hertz to the pitch scale in Bark approximates the values given in the literature. The resulting signals are known as the pitch power densities PPX(f)ₙ and PPY(f)ₙ.

To deal with the subjective impact of linear distortions as formed in the system under test, a (partial) frequency response compensation is executed in processing block 28. The pitch power densities PPX(f)ₙ and PPY(f)ₙ of the original and degraded pitch power densities are averaged over time. This average is calculated over speech active frames only using time-frequency cells whose power is more than 30 dB above the absolute hearing threshold. Per modified Bark bin, a partial compensation factor is calculated from the ratio of the degraded spectrum to the original spectrum. The maximum compensation is never more than 20 dB. The original pitch power density PPX(f)ₙ of each frame n is then multiplied with this partial compensation factor to equalise the original to the degraded signal. This results in a filtered version of the original pitch power density PPX′(f)ₙ. This partial compensation is used because severe filtering is disturbing to the listener while mild filtering effects hardly influence the perceived overall quality and intelligibility, especially if no reference is available to the subject. The compensation is carried out on the original signal because the degraded signal is the one that is judged by the subjects in an Absolute Category Rating (ACR) experiment.

Short-term gain variations are partially compensated by processing the pitch power densities frame by frame, as indicated in processing block 29. For the original and the degraded pitch power densities (PPX(f)ₙ and PPY(f)ₙ in the embodiment shown in FIG. 2), the sum in each frame n of all values that exceed the absolute hearing threshold is computed. The ratio of the power in the original and the degraded files is calculated and bounded to the range {3·10⁴, 5}. A first order low pass filter (along the time axis) is applied to this ratio. The time constant of this filter is approximately 16 ms. The distorted pitch power density in each frame, n, is then multiplied by this ratio, resulting in the partially gain compensated distorted pitch power density PPY′(f)ₙ.

After partial compensation for filtering and short-term gain variations in processing blocks 28, the original pitch power densities are transformed to a Sone loudness scale using Zwicker's law in processing block 31.

$${LX ( f )}_{n} = {S}_{t} \cdot {( \frac{{P}_{0} ( f )}{0.5} )}^{γ} \cdot [ {( 0.5 + 0.5 \cdot \frac{P P {{X}^{′} ( f )}_{n}}{{P}_{0} ( f )} )}^{γ} - 1 ]$$

with P₀(f) the absolute hearing threshold and S₁ the loudness scaling factor. In a similar manner, the output (or degraded) pitch power densities PPY′(f)ₙ is transformed in processing block 32. The resulting two dimensional arrays LX(f)ₙ and LY(f)ₙ are called loudness densities.

The signed difference between the distorted and original loudness density LX(f)ₙ and LY(f)ₙ is computed in processing block 34, labelled as perceptual subtraction. When this difference is positive, components such as noise have been added. When this difference is negative, components have been omitted from the original signal. This difference array is called the raw disturbance density.

Masking is modelled by applying a dead zone in each time-frequency cell, as follows. The per cell minimum of the original and degraded loudness density is computed for each time-frequency cell. These minima are multiplied by 0.25. The corresponding two dimensional array is called the mask array. Next the following rules are applied in each time-frequency cell:

If the raw disturbance density is positive and larger than the mask value, the mask value is subtracted from the raw disturbance;

If the raw disturbance density lies in between plus and minus the magnitude of the mask value the disturbance density is set to zero;

If the raw disturbance density is more negative than minus the mask value, the mask value is added to the raw disturbance density.

The net effect is that the raw disturbance densities are pulled towards zero. This represents a dead zone before an actual time-frequency cell is perceived as distorted. This models the process of small differences being inaudible in the presence of loud signals (masking) in each time-frequency cell. The result is a disturbance density function as a function of time (frame number n) and frequency, D(f)ₙ.

According to the present invention embodiments an additional processing step is introduced to obtain a better correlation between speech intelligibility scores and the final PESQ score I. The present invention embodiments use PESQ P.862.1 and P.862.2 (see reference [4] and [5]) as the starting point for an algorithm that can predict the perceived speech intelligibility of a speech fragment. The method can be used on normal speech material as well as on a short CVC test signal (Consonant Vowel Consonant). This test signal contains a set of short speech fragments, concatenated CVC words as used in speech intelligibility testing, that contains all relevant vowels and consonants, including the relevant transitions, and is put into the system under test.

The additional processing, which is shown schematically in FIG. 2 as processing blocks 50-55, is based on the insight that when two frames (frame length about 30 ms) within a speech signal are alike, i.e. a high correlation between their pitch power density functions, then the degradations as found by PESQ in the second frame are causing less decrease in intelligibility then predicted on the basis of the PESQ disturbance. When a sound is repeated subjects are able to better understands its meaning then when they hear the sound for the first time.

To quantify this effect the symmetric disturbance function D(f)ₙ as defined in PESQ is compensated for each time frame n with a correction function (frameCorrelationTimeCompensation) that is derived from the correlation between the current time frame pitch power density PPX′(f)ₙ and the previous independent time frame pitch power density PPX′(F)ₙ₋₂ of the reference input file.

With the term independent previous frame it is meant to have a previous frame which does not have any overlap with the present frame. E.g. the frames may be based on 50% overlapped cos² windows with index n, in which case the compensated pitch power density associated with the present frame n is correlated with compensated pitch power density associated with the second previous frame n−1.

This is calculated according to:

frameCorTimeOrg(n)=FrequencybandCorrelation(PPX′(f)ₙ,PPX′(f)ₙ₋₂)

In an embodiment, this function is calculated with the frequency index f: e.g. 100 Hz<f<3500 Hz, as only speech energy is important in the calculation. The present and previous time frame pitch power densities PPX′(f)ₙ, PPX′(f)ₙ₋₂ are stored in associated blocks 51, 52. The correlation calculation is implemented in processing block 50. Then, in processing block 53, the correction function is calculated according to:

if frameCorTimeOrg(n) < 0.0

frameCorrelationTimeCompensation = 1.0

else

frameCorrelationTimeCompensation = 1.0 −
( frameCorTimeOrg(n) )^{k};

if frameCorrelationTimeCompensation < 0.4

frameCorrelationTimeCompensation = 0.4

The value of the correction function frameCorrelationTimeCompensation is thus limited between a lower limit (in the example shown 0.4) and an upper limit (i.e. 1).

The predetermined power value k quantifies the point where the frameCorrelationTimeCompensation starts to have an impact. For low correlations the impact is marginal, only when the correlation is close to 1.0 the impact is significant. This leads to an optimal k>>1.0. In a specifically advantageous embodiment, the value k lies between 10 and 20.

In an embodiment of the present invention, first a speech signal X(t) containing the speech fragments with which the system under test 10 has to be evaluated is inputted to the measurement system 11. Next the internal representation as described in PESQ P.862[3], [4], [5] is calculated by the measurement system 11 for both the reference input X(t) and the degraded output Y(t) and from that the symmetric disturbance density D(f)ₙ (see above) and an asymmetric disturbance density DA(f)ₙ (see reference [3]). In the current best practice only the symmetric disturbance D(f)ₙ is used in combination with the frameCorrelationTimeCompensation as described above. For each frame n the corrected disturbance density D′(f)ₙ is calculated from the product of the disturbance density D(f)ₙ and the frameCorrelationTimeCompensation.

This corrected disturbance density is then integrated over the frequency, the speech spurts and the complete file length similarly as carried out in PESQ P.862 but with a low norm factor (power factor L_{q}) over frequency and spurt (e.g. L_{q}<2, e.g. L_{q}=1) and a high norm factor (power factor Lₚ) over time (e.g. Lₚ>6, e.g. Lₚ=8).

In processing block 35, an aggregation of disturbance densities over frequency is performed using the low norm factor L_{q} according to:

$${D}_{n} = {M}_{n} \sqrt[{L}_{q}]{{\sum }_{f = 1 , … Number of Barkbands} {( \vert {D ( f )}_{n} \vert {W}_{f} )}^{{L}_{q}}}$$

with Mₙ a multiplication factor equal to ((power of original frame+10⁵)/10⁷)^{-0.04}, resulting in an emphasis of the disturbances that occur during silences in the original speech fragment, and W_{f} a series of constants proportional to the width of the modified Bark bins. After this multiplication the frame disturbance values are limited to a maximum of 45. These aggregated values Dₙ are called frame disturbances.

In processing block 36, an aggregation of the frame disturbances over time is executed similarly using the low norm factor L_{q} for the speech spurts, and the high norm factor Lₚ for the aggregation over the entire speech sample.

In general, the existing PESQ methods also use a time weighting procedure, to account for the fact that disturbances that occur during speech active periods are more disturbing than those that occur during silent intervals:

$${L}_{p} = {( \frac{1}{N} {\sum }_{n = 1}^{N} {disturbance [ n ]}^{p} )}^{1 / p} ,$$

with N=total number of frames and p>1.0.
Such an Lₚ weighting emphasizes loud disturbances when compared to a normal, L₁ time averaging, leading to a better correlation between objective and subjective scores The aggregation of frame disturbances over time is carried in a hierarchy of two layers.

The present invention embodiments are somewhat different from the standard PESQ method (reference [3]). First, the aggregation over frequency is executed using a norm factor equal to 3 instead of the low norm value of 2 in the present embodiment. Furthermore, in the standard PESQ method, the frame disturbance values are aggregated over split second intervals of 20 frames (accounting for the overlap of frames: approx. 320 ms using a norm factor equal to 8. These intervals also overlap 50 percent and no window function is used. The split second disturbance values are aggregated over the active interval of the speech files (the corresponding frames) now using a norm factor equal to 2.

As a result, a disturbance indicator D is obtained, which can be further mapped onto a final CVC intelligibility score in processing block 37 (the quantity I in FIG. 1).

The present invention embodiments result in a quantity I that shows a strong correlation with the speech intelligibility of the output speech signal Y(t).

A further improvement can be obtained using an even further embodiment, from calculating the difference between two frequency, spurt, time integrations, both with a low Lₚ power (<3). In the above example, the integration over frequency, spurt, time integration has been done using 1, 1, and 8 as respective norm factors Lₚ, Lₚ, L_{q}. In this further example, two calculations are made which are then subtracted from each other. E.g., a first calculation is made using 2, 3, 2 as respective norm factors for the integration over frequency, spurt and entire speech sample, and a second calculation using 1, 3, 3, as respective norm factors.

The present invention has been described above by means of exemplary embodiments. As will be clear to the skilled person, further modifications and alternatives may be used that are within the scope of the appended claims.

### REFERENCES

[1] A. W. Rix, M. P. Holier, A. P. Hekstra and J. G. Beerends, “PESQ, the new ITU standard for objective measurement of perceived speech quality, Part 1—Time alignment,” J. Audio Eng. Soc., vol. 50, pp. 755-764 (2002 October).
[2] J. G. Beerends, A. P. Hekstra, A. W. Rix and M. P. Hollier, “PESQ, the new ITU standard for objective measurement of perceived speech quality, Part II—Perceptual model,” J. Audio Eng. Soc., vol. 50, pp. 765-778 (2002 October) (equivalent to KPN Research publication 00-32228).
[3] ITU-T Rec. P.862, “Perceptual Evaluation Of Speech Quality (PESQ): An Objective Method for End-to-end Speech Quality Assessment of Narrow-band Telephone Networks and Speech Codecs,” International Telecommunication Union, Geneva, Switzerland (2001 February).
[4] ITU-T Rec. P.862.1, “Mapping function for transforming P.862 raw result scores to MOS-LQO,” Geneva, Switzerland (2003 November).
[5] ITU-T Rec. P.862.2, “Wideband extension to Recommendation P.862 for the assessment of wideband telephone networks and speech codecs,” Geneva, Switzerland (2005 November).
[6] A. P. Hekstra, J. G. Beerends, “Output power decompensation,” International patent application 402714; PCT EP02/02342; European patent application 01200945.2, March 2001; Koninklijke PTT Nederland N.V.
[7] J. G. Beerends, “Frequency dependent frequency compensation,” International patent application 402736; PCT EP02/05556; European patent application 01203699.2, June 2001; Koninklijke PTT Nederland N.V.
[8] J. G. Beerends, “Method and system for measuring a system's transmission quality,” Softscaling, International patent application 402808; PCT EP03/02058; European patent application 02075973.4-2218, April 2002, Koninklijke PTT Nederland N.V.
[9] J. G. Beerends, “Filter scale loop,” International patent application 402894; European patent application EP03075949.2, July 2003, Koninklijke PTT Nederland N.V.
[10] T. Goldstein, J. G. Beerends, H. Klaus and C. Schmidmer, “Draft ITU-T Recommendation P.AAM, An objective method for end-to-end speech quality assessment of narrow-band telephone networks including acoustic terminal(s),” White contribution COM 12-64 to ITU-T Study Group 12, September 2003.
[11] J. G. Beerends, “Linear frequency distortion impact analyzer,” International patent application; European patent application EP04077601, November 2004, TNO Nederland N.V.
[12]H. J. M. Steeneken and T. Houtgast, “A physical method for measuring speech-transmission quality,” J. Acoust. Soc. Am., vol. 67, pp. 318-326 (1980 January).
[13] IEC, Publication 268-16, Sound system equipment, Part 16: The objective rating of speech intelligibility in auditoria by the RASTI method, 1988
[14] ISO, Technical Report 4870, Acoustics—The construction and calibration of speech intelligibility tests, 1991
[15] H. J. M. Steeneken, “On measuring and predicting speech intelligibility,” PhD University of Amsterdam (1992).
[16] J. G. Beerends and J. A. Stemerdink, “A Perceptual Audio Quality Measure based on a psychoacoustic sound representation,” J. Audio Eng. Soc., vol. 40, pp. 963-978 (1992 December).

1-10. (canceled)

11. A method for measuring speech intelligibility of an audio transmission system, wherein an input signal is entered into the audio transmission system, resulting in an output signal, and wherein both the input signal and the output signal are processed, the method comprising:
preprocessing of the input signal and the output signal to obtain pitch power densities for the respective signals, comprising pitch power density values for cells in the frequency and time domain;
compensating the respective pitch power densities to obtain respective compensated pitch power densities;
transforming the respective compensated pitch power densities into loudness densities;
performing perceptual subtraction of the loudness densities to obtain a disturbance density function;
multiplying the disturbance density function with a correction function for each frame derived from a correlation calculation of the compensated pitch power density associated with the input signal of a present frame and an independent previous frame to obtain a corrected disturbance density function; and
aggregating the corrected disturbance density function over frequency and time to obtain a measure for the speech intelligibility of the audio transmission system.
